(19) United States
(12) Patent Application Publication
(10) Pub. No.: US 2008/0241956 A1
(43) Pub. Date: Oct. 2, 2008

(54) METHOD FOR DETECTING ANALYTE AND BIOCHIP

(75) Inventors: Fumiko Hirai, Ashigarakami-gun (JP); Yasunori Ichikawa, Ashigarakami-gun (JP); Kazunori Takahashi, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/058,718

(22) Filed: Mar. 30, 2008

(30) Foreign Application Priority Data
Mar. 30, 2007 (JP) 2007-095560

(51) Int. Cl. G01N 1/28; B01J 19/00

(52) U.S. Cl. 436/174; 422/68.1

(57) ABSTRACT

A method for detecting an analyte in a sample liquid, using a detection reagent which reacts specifically with the analyte to give structural information on the analyte, comprising the steps of:
a step of dropping the sample liquid containing the analyte onto a substrate and evaporating a solvent in the droplet by feeding a gas to the droplet; and
a step of contacting the droplet with the detection reagent.

### BACKGROUND OF THE INVENTION

1. Field of the Invention

The present invention relates to a method for detecting an analyte and to a biochip, especially to a method for acquiring biomolecular information by a reaction with a biomolecule.

2. Description of the Related Art

In the recent years many studies have addressed to detection of a biomolecule sampled from an organism by an in vitro reaction. For example, described in Japanese Patent Application Laid-Open No. 2000-72822, by using a DNA-chip on which surface artificially prepared DNAs are immobilized and identifying a nucleotide sequence on the chip, to which a DNA sampled from an organism binds specifically, certain genetic information can be obtained. Likewise the detection method is prevailing, in which a detection reagent that reacts specifically with an analyte and is immobilized on a substrate is contacted with a sample liquid containing an analyte for detecting the same.

In this case, formation of a complex between an analyte in a sample liquid and a detection reagent on the substrate is detected. For this purpose, the sample liquid must be held on the substrate surface for a period required for forming a detectable amount of the complex. Certain purpose of the detection or certain nature of the detection reaction may require quick progress of such reaction. It is consequently desired to minimize the reaction time as much as possible by shortening the diffusion distance between the analyte in the sample liquid and the detection reagent on the substrate to shorten the diffusion time.

For this purpose, Japanese Patent Application Laid-Open No. 05-256749 discloses a method to evaporate a solvent in a droplet held at an end of a capillary by vacuuming the surroundings of the droplet. According to the document, concentrating to an analyzable level is possible. Another method has been proposed, in which a sample droplet is dropped onto a sample plate surface treated chemically, for concentrating by spontaneous drying. The above methods utilize the character of a micro-fluid having a large specific area, in other words, a large evaporation surface of the solvent.

By the method described in Japanese Patent Application Laid-Open No. 05-256749, although a droplet can be concentrated, a separate step of adding of a detection reagent is necessary after the concentration, which is not only troublesome but also requires a long time for the reaction between an analyte and the detection reagent. A possible requirement for short-time execution of both concentration and reaction with a sample for detection in accordance with a purpose of the analysis or a nature of the sample liquid, can not be fulfilled by the aforementioned method.

### SUMMARY OF THE INVENTION

Under such circumstances, an object of the present invention is to provide a method for detecting an analyte, which concentrates efficiently a droplet and enables efficient contact between the analyte in the droplet and a detection reagent to cause a detection reaction accurately and quickly, as well as a biochip therefor.

For the aforementioned object, the method described in a first aspect of the present invention provides a method for detecting an analyte in a sample liquid, using a detection reagent which reacts specifically with the analyte to give structural information on the analyte, comprising the steps of: a step of dropping the sample liquid containing the analyte onto a substrate and evaporating a solvent in the droplet by feeding a gas flow; and a step of contacting the droplet with the detection reagent.

In the method of the first aspect, both a step of evaporating volatile components (such as a solvent) in the droplet of the sample liquid containing an analyte by feeding a gas flow, and a step of contacting the analyte with the detection reagent are carried out. This improved method realizes efficient concentration of a droplet and efficient contact between the analyte in the droplet and the detection reagent to cause a detection reaction accurately and quickly.

Further, the shear force by the gas flow into the droplet worked on the droplet surface fluidizes the inside of the droplet, which enhances the efficiency of the contact in the droplet between the analyte and the detection reagent.

The order of the concentration step and the detection reaction step is not particularly limited. For example, a droplet may be first concentrated and then contacted with a detection reagent for reaction, or the concentration of a droplet and the reaction with a detection reagent may be carried out simultaneously. An analyte hereunder includes a detection target substance inherently contained in the sample liquid, as well as a signaling substance which signals by reacting further with a detection reagent that has been reacted with the analyte.

The method of a second aspect of the present invention is characterized in that the detection reagent is immobilized on the substrate in the method of the first aspect.

This can shorten the reaction time, since the concentration of a droplet and the reaction with a detection reagent can be carried out simultaneously.

The method of a third aspect of the present invention is characterized in that the solvent in the droplet is evaporated by heating the droplet in the method of the first or second aspect.

This can accelerate the evaporation speed of the solvent in the droplet, enabling quick concentration.

The method of a fourth aspect of the present invention is characterized in that a concentration of the solvent in the gas is decreased in the method in any one of the first to third aspects.

This can shorten the concentration time, since the evaporation speed of the solvent in the droplet can be further increased.

The method of a fifth aspect of the present invention is characterized in that the detection reagent is a biomolecule in the method in any one of the first to fourth aspects.

The method of a sixth aspect of the present invention is characterized in that the biomolecule includes at least one of an amino acid, a peptide, a protein and a nucleic acid in the method in any one of the first to fifth aspects.

For the aforementioned object, the present invention provides a biochip for detecting an analyte in a sample liquid according to a seventh aspect of the present invention, characterized in that the biochip comprises a substrate with an immobilized detection reagent which reacts specifically with the analyte contained in the sample liquid to give structural information on the analyte; a space formed on the substrate for contacting the detection reagent with a droplet of the sample liquid; an inflow channel connecting to an end of the space for feeding a gas to the droplet; and an outflow channel connecting to the opposite side of the space for venting the gas from the space, while a hydrophobic region is formed on the substrate in the space.

A droplet containing water as a major component spreads out with a small contact angle on the hydrophilic surface of a substrate, by which uneven concentrating may take place by a gas flow. The chip of the seventh aspect can assure a large contact angle of the droplet on the substrate, which suppresses uneven concentration in the droplet and concentrates the same homogeneously. The term “droplet” herein refers to a sample liquid with a curved surface.

The biochip of an eighth aspect of the present invention is characterized in that a hydrophilic region is formed inside the hydrophobic region in the biochip of the seventh aspect.

Since the hydrophilic region is formed inside the hydrophobic region according to an eighth aspect of the present invention, the droplet can remain stable even in the gas stream, while maintaining an appropriate contact angle to the substrate surface. Further, substantially uniform concentration throughout the droplet is possible, since the droplet can be confined within the hydrophilic region during the concentration.

The biochip of a ninth aspect of the present invention is characterized in that a hollow is formed in the space to accommodate the sample liquid in the biochip of the seventh or eighth aspect.

According to the ninth aspect of the present invention, the sample liquid can be filled in the hollow and the droplet can be placed on the surface thereof. The droplet boundary on the liquid surface has a larger contact surface area with the gas and quicker solvent evaporation is possible within the droplet, while the evaporation of the solvent from the sample liquid in the hollow is slow due to a smaller contact surface area with the gas. Consequently even after the active evaporation of the solvent from the droplet surface, the concentrated sample liquid can remain in the hollow and an over-concentration can be suppressed.

The biochip of a tenth aspect of the present invention is characterized in that the inflow channel and the outflow channel are microchannels with an equivalent diameter of 1 mm or less in the biochip of any one of the seventh to ninth aspects.

By feeding a gas in the inflow channel with an equivalent diameter of 1 mm or less according to the tenth aspect of the present invention, a laminar flow tends to be formed, which effects a shear force on the droplet surface to fluidize the inside of the droplet and to further enhance the contact efficiency between the analyte and the detection reagent. The equivalent diameter of 0.5 mm or less is more preferable.

The biochip of an eleventh aspect of the present invention is characterized in that an apparatus for heating the droplet in the space is provided in the biochip of any one of the seventh to tenth aspects.

As the apparatus for heating, for example, various heaters are exemplified.

The biochip of a twelfth aspect of the present invention is characterized in that an apparatus for adjusting the concentration of the solvent in the gas to adjust the concentration of the solvent in the gas is provided in the biochip of any one of the seventh to eleventh aspects.

As the apparatus for adjusting the concentration of the solvent, for example, a condensing and/or cooling apparatus for condensing moisture or a solvent in the gas may be exemplified.

The biochip of a thirteenth aspect of the present invention is characterized in that the detection reagent is a biomolecule in the biochip of any one of the seventh to twelfth aspects.

The biochip of a fourteenth aspect of the present invention is characterized in that the biomolecule includes at least one of an amino acid, a peptide, a protein and a nucleic acid in the biochip of any one of the seventh to thirteenth aspects.

The present invention realizes efficient concentration of a droplet and efficient contact between an analyte in the droplet and a detection reagent to cause a detection reaction accurately in a short time.

### BRIEF DESCRIPTION OF THE DRAWINGS

FIG. 1 is a schematic drawing illustrating an exemplary structure of a biochip to which the method for detecting an analyte according to the present invention is applied:

FIG. 2 is a cross-sectional view taken along the line A-A in FIG. 1;

FIGS. 3A and 3B are enlarged cross-sectional views of the vicinity of the port 18A in FIG. 1;

FIG. 4 illustrates an action mechanism of the present embodiment;

FIGS. 5A and 5B illustrate another example of the surface appearance of the substrate with a droplet placed;

FIGS. 6A to 6C illustrate an action mechanism of FIGS. 5A and 5B;

FIGS. 7A and 7B illustrate another example of the droplet retention forms in the present embodiment;

FIGS. 8A to 8C illustrate an action mechanism of FIGS. 7A and 7B;

FIG. 9 illustrates an alternative example of a biochip according to the present invention; and

FIG. 10 illustrates an alternative example of a biochip according to the present invention.

### DETAILED DESCRIPTION OF THE PREFERRED EMBODIMENTS

More details of a preferred embodiment of the method for detecting an analyte and the biochip according to the present invention will be illustrated below with reference to the attached drawings.

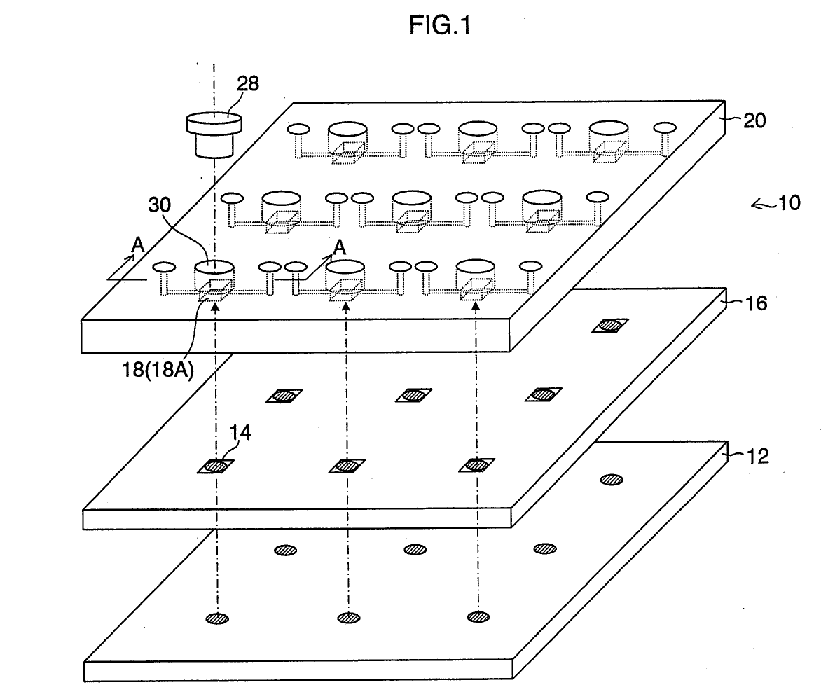

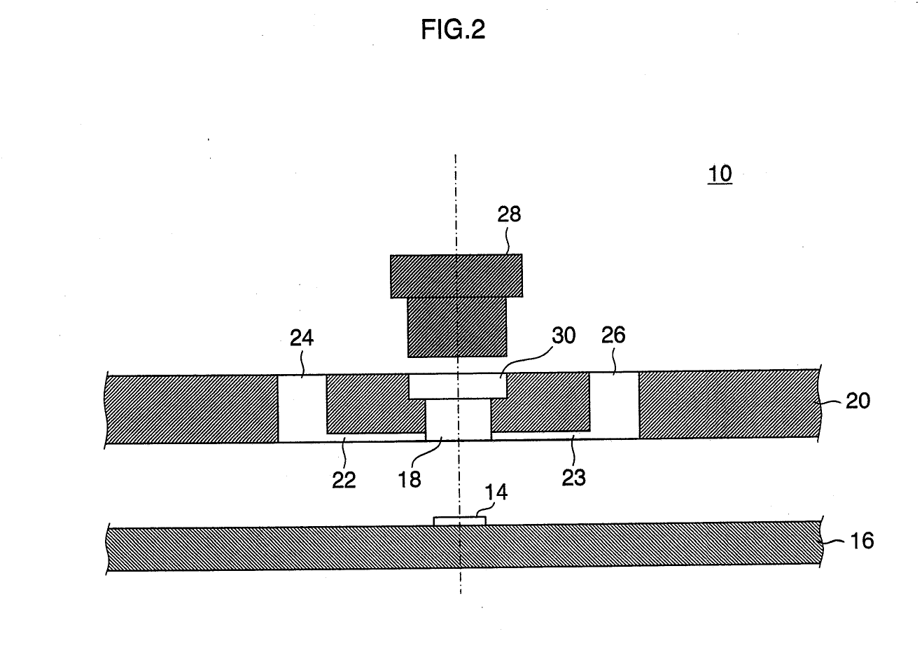

FIG. 1 is a schematic drawing illustrating an exemplary structure of a biochip 10 to which the method for detecting an analyte according to the present invention is applied. FIG. 1 depicts a status where the biochip 10 is attached to a sensor (analyzer) 12. FIG. 2 is a cross-sectional view taken along the line A-A in FIG. 1.

This embodiment is a method in which, upon placing a droplet containing an analyte on an antibody previously immobilized on a substrate for an antigen-antibody reaction, dry air is fed to the droplet to evaporate a solvent in the droplet to concentrate in order to increase the reaction rate of the analyte in the droplet.

As shown in FIGS. 1 and 2, the major components of the biochip 10 are a substrate 16 composed of a plate and a detection reagent 14 immobilized on the surface thereof, which reacts specifically with an analyte, and a cover plate 20 with hollows 18 to form ports 18A to accommodate droplets on the substrate 16 by combining with the surface thereof tightly.

Grooves 22, 23 of the cover plate 20 are connected to both the sides of the hollow 18. The other end of the groove 22 is connected to an inlet 24 formed in the cover plate 20 as a cylindrical cavity and the other end of the groove 23 is connected to an outlet 26 formed in the cover plate 20 as a cylindrical cavity. By closing the hollows 18 and grooves 22, 23 formed on the surface of the cover plate 20 with the substrate 16, ports 18A, channels 22A and channels 23A are constructed.

The upper part of a port 18A is connected with a cylindrical cavity 30, which can be closed with a sealing element 28. A droplet may be placed through the cylindrical cavity 30 into the port 18A.

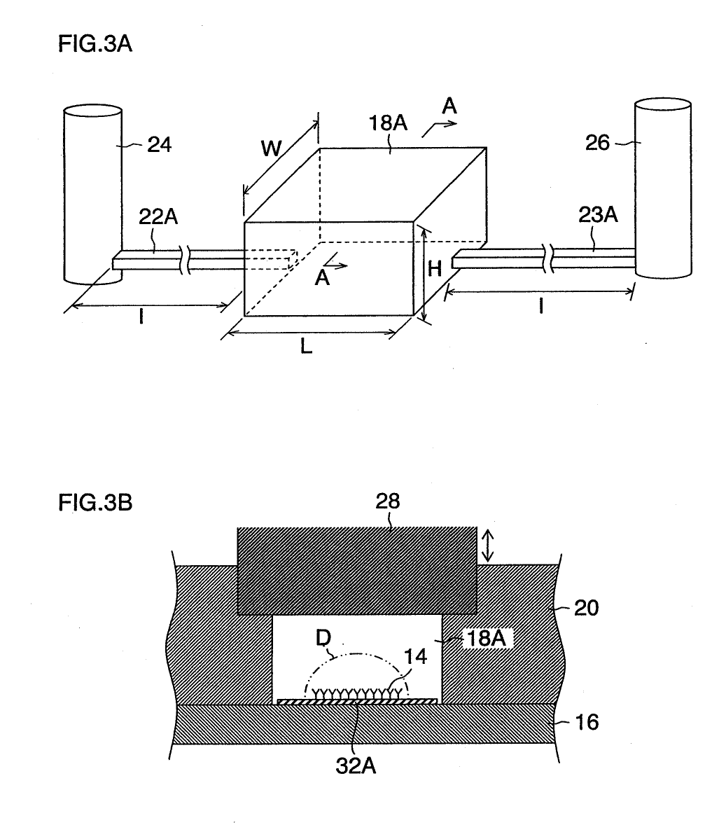

FIGS. 3A and 3B are enlarged cross-sectional views of the vicinity of the port 18A. Thereunder FIG. 3A is an enlarged perspective view of the vicinity of a port 18A and FIG. 3B is a cross-sectional view taken along the line A-A in FIG. 3A.

The port 18A is so sized that a droplet can be placed on the detection reagent 14 immobilized on the surface of the substrate 16 as shown in FIG. 3B. An example of the size of a port 18A may be a width W of 5 mm, a length L of 5 mm, and a height H of 3 mm. The cross-sectional form of the port 18A is not limited to rectangle as exemplified in FIG. 3B, and such other forms as trapezoid, V-shape, semicircle may be used.

At the locations corresponding to the ports 18A on the substrate 16, hydrophobic regions 32A are formed and the detection reagent 14 is immobilized thereon as shown in FIG. 3B.

The hydrophobic region 32A is a layer that has low affinity to a droplet D formed, for example, by various surface chemical treatments such as a water-repellent coating. The hydrophobic region 32A is so formed that the contact angle of the droplet D with the surface of the substrate 16 is 90° or larger. As a result, a contact angle of the droplet D with the surface of the substrate can be increased and uneven concentration by uneven distribution of a droplet over the substrate can be suppressed.

As a detection reagent 14, any substance which can react specifically with an analyte to acquire information on the analyte can be used without limitation, and, for example, various antibodies can be used. As a method for immobilizing the detection reagent 14, for example, jetting the detection reagent 14 onto the substrate 16 through a nozzle of an ink-jet apparatus can be successfully applied to immobilize the detection reagent 14. However, the method for immobilization is not limited thereto.

The volumes of an inlet 24 and an outlet 26 are not particularly limited as far as the pressure loss when streamed with a fluid is not excessively high. For example, a preferable range is 5 to 5,000 mm³. With such a volume range, it is easy to control various phenomena which may occur in micro-channels.

There are no restrictions on the planar sizes of the substrate 16 and the cover plate 20. A portable size, for example 40×40 mm, may be chosen. Similarly there are no restrictions on the thickness of the substrate 16 and the cover plate 20, however from the viewpoints of strength and economy, for example, approximately 1 mm for the substrate 16 and 5 mm for the cover plate 20 may be chosen.

There are no restrictions on the cross-section area of the grooves 22, 23, but the area is preferably set in such a range as to form a laminar flow over the droplet surface in a port 18A. The cross-section area of the grooves 22, 23 is thus preferably 1 mm² or less, more preferably 0.0025 to 0.64 mm², and most preferably 0.01 to 0.25 mm². There are no restrictions on the shapes of the cross-sections of the grooves 22, 23, and various shapes such as rectangle (square, oblong), trapezoid, V-shape, semicircle shapes can be adopted. Further, the length 1 of the grooves 22, 23 is not particularly limited, and may be, for example, approximately 10 mm.

There are no restrictions on the material of the substrate 16 and the cover plate 20, but a transparent material is preferable to recognize visually the status of a droplet in a port 18A. For example, various resin plates such as polydimethyl sulfoxide (PDMS), polymethyl methacrylate (PMMA), polyvinyl chloride (PVC), UV-curing resins, polycarbonate (PC), and various resin films such as polyethylene terephthalate (PET), polyethylene naphthalate (PEN), triacetyl cellulose (TAC) may be used.

As additional preferable materials for the substrate 16 and the cover plate 20, metals, glass, ceramics, plastics, silicones and Teflon may be selected according to the respective requirements on heat resistance, pressure resistance, solvent resistance, processability etc., and a polystyrene resin, a PMMA resin, quartz glass, and Pyrex glass are preferably used.

To fabricate a cover plate 20 with a minute port 18A and grooves 22, 23, micromachining technology is successfully applied. The micromachining technology includes the following examples.

(1) LIGA technology combining X-ray lithography and electroplating,

(2) High aspect ratio photolithography using EPON SU8,

(3) Mechanical micro-cutting fabrication (e.g. micro-drilling using a high-speed rotating drill with a micro-order diameter),

(4) High aspect ratio silicon fabrication using Deep RIE,

(5) Hot-Emboss technique,

(6) Stereo lithography,

(7) Laser ablation, and

(8) Ion-beam milling.

To a biochip 10 thus constructed, a detection sensor 12 is so attached that the light therefrom irradiates each of many droplets placed on the substrate 16 to analyze spectroscopically the complex generated in the droplets.

Any gas can be used for the present invention as far as it is inerted to a sample liquid containing an analyte. Preferable examples are dry air and nitrogen.

There are no restrictions on an analyte to be used according to the present invention, and biomolecules such as an amino acid, a peptide, a protein and a nucleic acid are included.

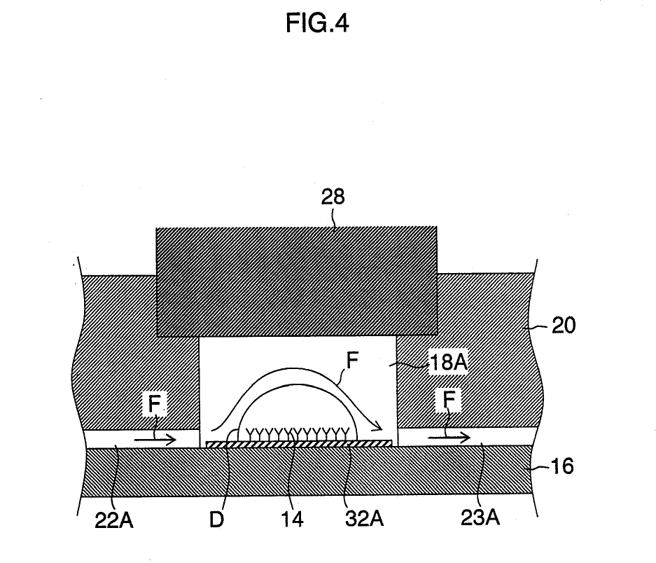

Next, a procedure for detecting an analyte according to the present invention using a biochip 10 thus constructed will be described with reference to FIG. 4. FIG. 4 illustrates exemplarily an action mechanism of the present invention.

A sample liquid is dropped into a port 18A, to which bottom a detection reagent 14 has been immobilized, and then the port 18A is closed with a sealing element 28. The amount of the droplet is preferably 50 μL or less, more preferably 10 μL or less. An analyte in the droplet D is allowed to contact for reaction with the detection reagent 14 on the substrate 16.

Thereby a gas for concentrating a droplet D (e.g. dry air) is fed (arrow F) from an inlet 24 through a channel 22A to a port 18A using a pump and the like (not shown). A solvent in the droplet D starts evaporating, since the droplet D has a broad boundary surface with the gas. A decrease in the evaporation speed does not occur even when the evaporated solvent from the droplet D is saturated in the port 18A, since the gas is constantly flowing even after evaporation of the solvent form the droplet.

The gas flown through the port 18A evacuates through a channel 23A and an outlet 26.

After the droplets D are concentrated to a predetermined concentration, the gas flow is stopped, and, if required, a signaling substance for detection is added to the droplets D, and then the analyte is detected spectroscopically or visually.

According to this embodiment, a droplet can be concentrated in a short period by a gas flow to a droplet, which can enhance the efficiency of the contact in the droplet between an analyte and a detection reagent.

Further, the shear force by the gas flow onto a droplet worked on the droplet surface can fluidize and agitate the inside of the droplet.

This can enhance the efficiency of the contact with the detection reagent 14 on the substrate 16, enabling quick and accurate detection.

Further, by using a biochip arrayed with many spots of detection reagent(s) 14, reproducibility determination or different types of analyses can be performed with a single test.

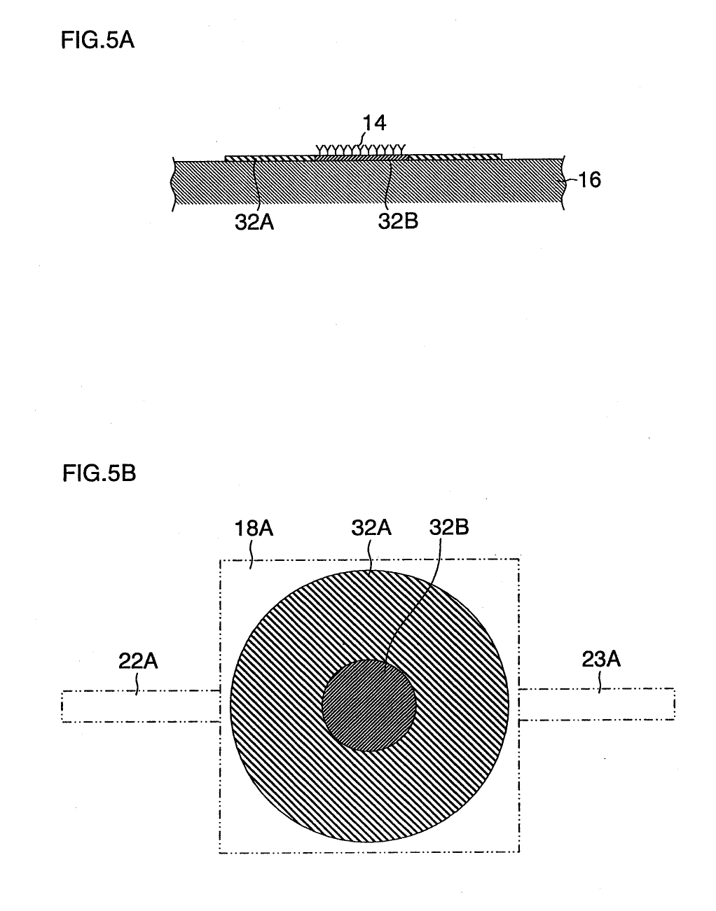

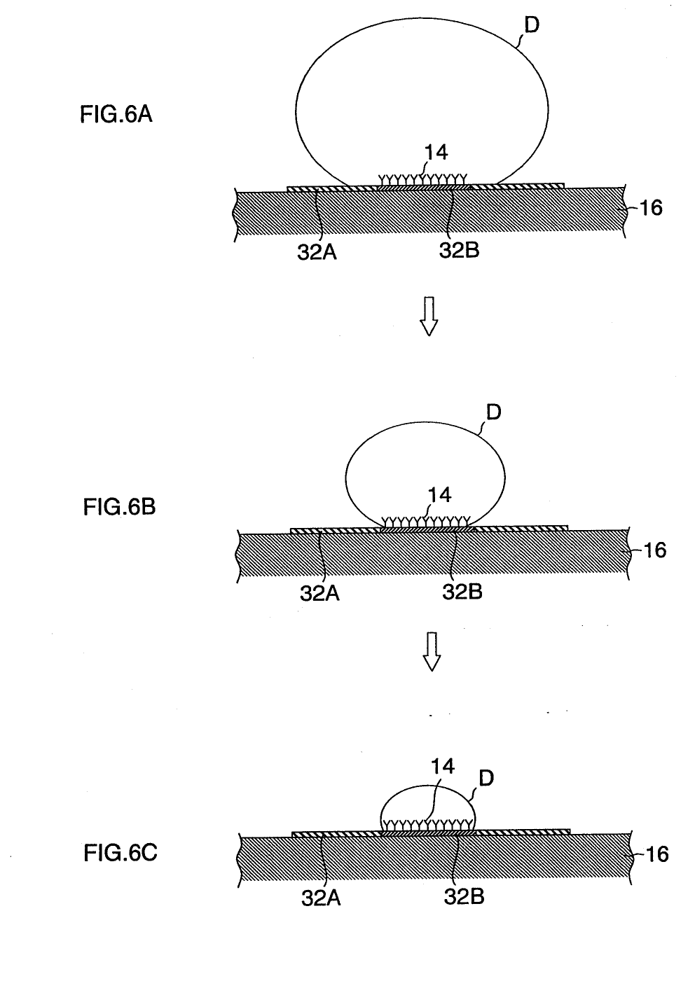

FIGS. 5A and 5B illustrate another example of the surface appearance of the substrate 16 with a droplet placed. FIG. 5A is a side view of the substrate 16, and FIG. 5B is a top view of the same. FIG. 6 illustrates an action mechanism of FIGS. 5A and 5B.

At a location of the substrate 16 where a droplet D is expected, a hydrophobic region 32A is formed, and inside the same a hydrophilic region 32B with an immobilized detection reagent 14 is formed as shown in FIGS. 5A and 5B.

A hydrophilic region 32B can stably retain a droplet D (in case of a droplet D with water as a solvent), since its affinity with the droplet D is high. While the hydrophobic region 32A can hardly immobilize the droplet D due to its low affinity with the droplet D. Not limited to FIGS. 5A and 5B, any other aspects may be employed, so long as the hydrophilic region 32B and the detection reagent 14 are within the hydrophobic region 32A by a top view of the substrate 16 in the port 18A.

For example, the diameter of a hydrophobic region 32A may be about 1.5 mm, and the diameter of a hydrophilic region 32B may be about 0.5 mm. The diameter of a hydrophilic region 32B may be determined according to the desired final amount of the concentrated sample liquid.

There are no restrictions on the methods for forming a hydrophobic region 32A and a hydrophilic region 32B, and any known methods such as chemical surface treatment may be used.

As shown in FIG. 6A, at the early stage of the concentration a boundary surface of a droplet D contacts a hydrophobic region 32A, but with the progress of the concentration the droplet boundary retreats toward the center of the droplet D due to the low wettability to the substrate 16. At the later stages shown in FIG. 6B and in FIG. 6C, the droplet D is concentrated further, while it is being held stably in a hydrophilic region 32B.

By locating a hydrophilic region 32B within a hydrophobic region 32A, the moving droplet boundary during the concentration can be stably held in the hydrophilic region 32B. Consequently, the concentrated sample liquid can be efficiently centralized on the substrate 16.

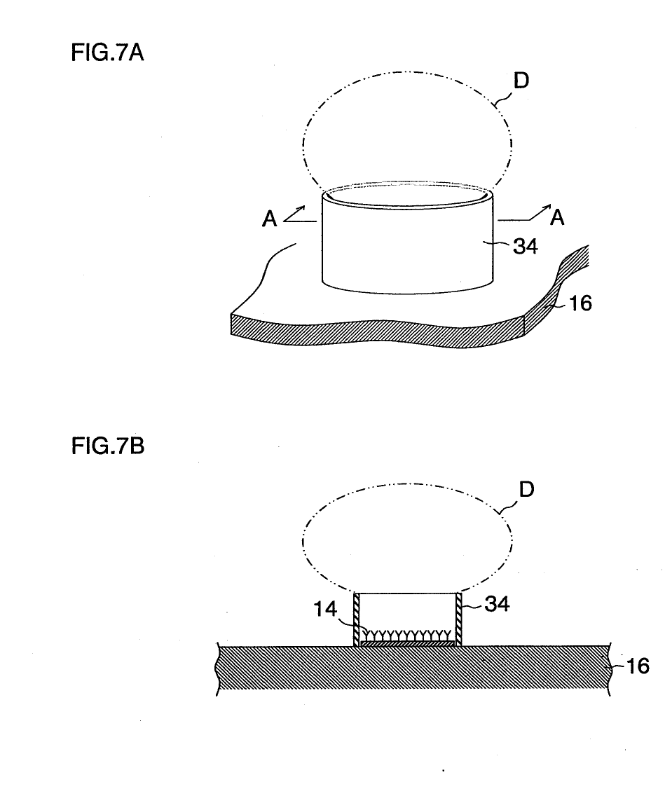

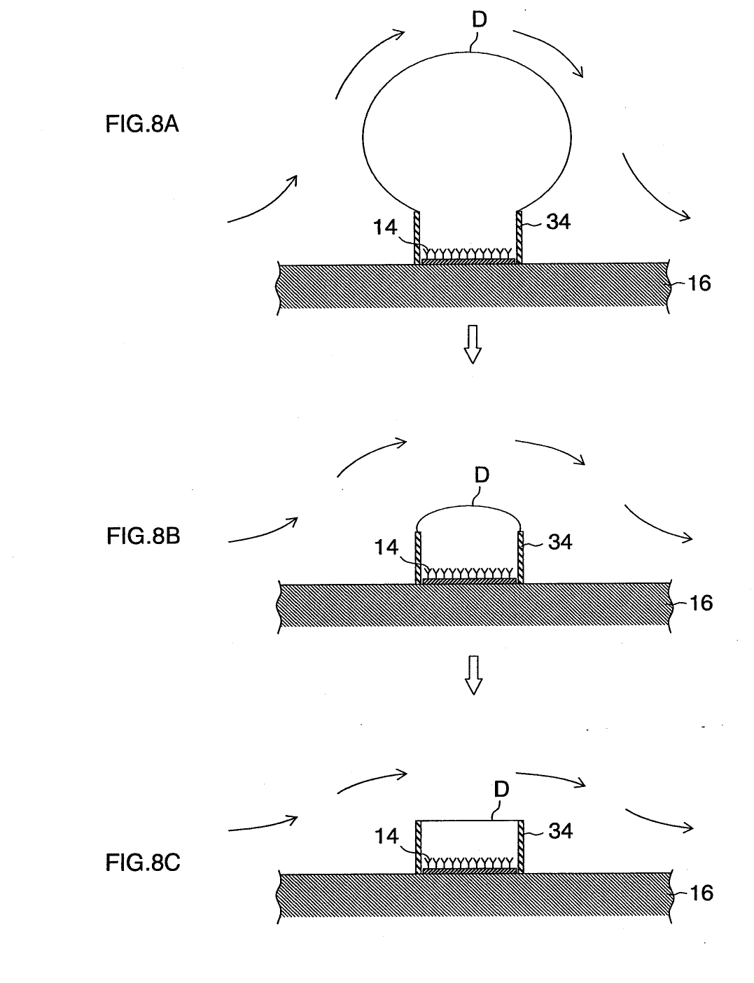

FIGS. 7A and 7B illustrate another example of an alternative droplet retention form. Thereby FIG. 7A is a perspective view of a part of the substrate 16 in a port 18A, and FIG. 7B is a cross-sectional view taken along the line A-A in FIG. 7A. FIGS. 8A to 8C illustrate an action mechanism of FIGS. 7A and 7B.

As shown in FIGS. 7A and 7B, a cylindrical cavity 34 may be constructed at the substrate 16, where a droplet D is to be placed.

As shown in FIG. 7B, at the bottom of a cylindrical cavity 34 a detection reagent 14 is immobilized. It is preferable to determine the diameter and height of a cylindrical cavity 34 according to the desired final amount of a sample liquid after the concentration.

As shown in FIG. 8A, a sample liquid is filled into a cylindrical cavity 34, and added above its level to form a droplet D. Then a gas feed (arrow) is started.

As shown in FIG. 8B, a solvent starts evaporating from the boundary surface of a droplet having a large contact area with the gas, and the size of the droplet gradually contracts.

At the stage shown in FIG. 8C, when the liquid is so much concentrated that the droplet D formed above the cylindrical cavity 34 substantially disappears, further concentration is retarded due to the limited contact with the gas. As the result the concentrated sample liquid remains solely in the cylindrical cavity 34.

As described above, a risk of over-concentration can be minimized and a detectable amount of a sample liquid remains. Consequently a droplet can be efficiently concentrated and the contact efficiency between an analyte in the droplet and a detection reagent is enhanced, which enables an accurate and quick detection reaction.

Although an example of a cylindrical cavity 34 is shown in FIGS. 7A and 7B, other shapes such as a rectangular cavity may be used, or a hollow may be formed in the substrate 16 to receive a sample liquid.

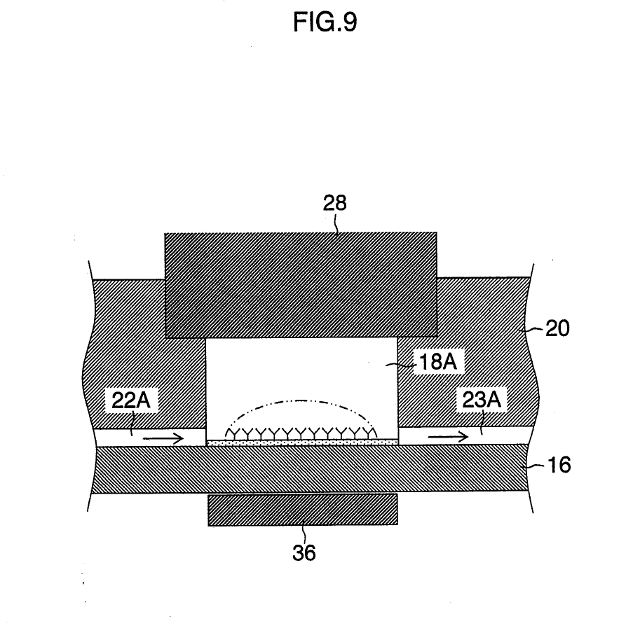

FIG. 9 illustrates an alternative example of a biochip 10.

As shown in FIG. 9, a substrate 16 or a cover plate 20 may be preferably equipped with a heating apparatus 36.

An example of a heating apparatus 36 is a metal resistance heater or a polysilicon heater, which is built in the sensor 12. The temperature is regulated by a thermal cycle of heating with a metal resistance or a polysilicon heater, and cooling by natural cooling. Generally as a temperature sensor, with a metal resistance heater one of the two same resistance lines is used for temperature-sensing based on its resistance change, and with a polysilicon heater a thermocouple is used.

Alternatively, a Peltier-element is integrated in a biochip 10 to control precisely the temperature. In any event, the temperature control can be conducted using a traditional temperature control technique, or a newer technique including a Peltier-element. An appropriate combination of a heating and cooling system, a sensing system and an external regulating system may be selected according to materials of a substrate 16 or a cover plate 20.

Since the temperature of a droplet is lowered by the evaporation of a solvent, the heating temperature is preferably 40° C. or lower.

By the heating, the evaporation of the solvent is accelerated to shorten the concentration time of a droplet D.

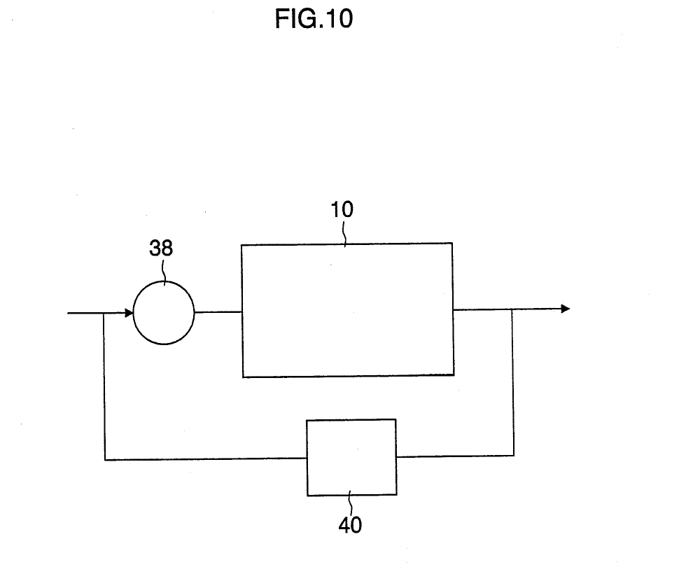

FIG. 10 illustrates an alternative example of a biochip 10.

As shown in FIG. 10, it is preferable to install a solvent concentration adjustment apparatus 40 for controlling the solvent concentration in the gas to be fed to the biochip 10.

There are no restrictions on the types of a solvent concentration adjustment apparatus 40, and any apparatus for cooling or compressing the gas to be fed to a droplet may be used. More particularly, a temperature controlling apparatus such as a Peltier-element described above can be used favorably.

For example, if a gas is recycled to the biochip 10 as shown in FIG. 10, the gas having passed through the biochip 10 is fed to the solvent concentration adjustment apparatus 40 for condensing to lower the moisture of the gas before recycling by a pump 38 into the biochip 10. Thereby continuously the dry gas is fed to the droplet D, so that the solvent evaporation from the droplet D is further accelerated.

Although some preferable embodiments of the present invention for a method for detecting an analyte and a biochip are described above, the present invention is not limited thereto and other various embodiments can be adopted.

For example, in the above embodiments a gas is actively fed to a sample liquid to accelerate the solvent evaporation, it is possible to concentrate a droplet by evaporating the solvent without a gas flow (with a natural convection only). In such case it is preferable to lower the solvent concentration (such as moisture) in the atmosphere around the droplet.

In the above embodiments, although a sample liquid containing a biomolecule such as an antigen or an antibody is used, any other sample liquid may be used for analyses.

In the above embodiments, a sample liquid containing an analyte is dropped onto a substrate, on which a detection reagent 14 has been immobilized beforehand. The method according to the present invention is not limited thereto, however, and a detection reagent 14 may be dropped onto a substrate, on which a sample liquid has been dropped.

In the above embodiments, although a sample liquid is poured through a cylindrical cavity 30 which can be closed by a sealing element 28, any other structure without the same may be employed. For example, with a disassembled substrate 16 and a cover plate, a droplet is formed on the substrate 16, which is thereafter covered with the cover plate to have a droplet in the biochip.

In the above embodiments, a biochip is described, in which a channel 22A, a port 18A and a channel 23A are collinear. Not limited thereto, however any structure may be used, so long as a gas can flow to a droplet in a port 18A. In the aspect of FIG. 1, a gas inflow channel 22A and an outflow channel 23A are provided for each port 18A, independently, but a structure with a common inflow channel (or an outflow channel) for all the ports 18A arrayed on the same row or column may be used (for example, channels connected to the respective ports are interconnected to form a common channel).

### EXAMPLE

Using a biochip 10 of FIG. 1, reaction rates required for detecting a CRP (C-reactive protein) antigen were compared.

A polystyrene sheet with a thickness of 1 mm was used as the substrate 16. At the bottom of a port 18A of the biochip 10, an antibody (a detection reagent 14) binding specifically to the CRP antigen was immobilized, and 1 μL of PBS (phosphate buffer saline) containing 5 μg/mL of a CRP antigen (an analyte) was dropped thereto.

Then dry air (moisture 4%) was fed through an inlet 24 of the biochip 10. After incubating with a labeling antibody for about 15 min, the fluorescent signal was detected.

As a Comparative Example, the same test was performed, except that wet air (moisture 70%) was used instead of the dry air.

In Example, a strong fluorescent signal was detected, but the signal was hardly detected in the Comparative Example.

The above results demonstrated that, according to the present invention, a low concentration sample liquid could be efficiently concentrated and an analyte in the sample liquid could be detected in a short time.

What is claimed is:

1. A method for detecting an analyte in a sample liquid, using a detection reagent which reacts specifically with the analyte to give structural information on the analyte, comprising the steps of:
a step of dropping the sample liquid containing the analyte onto a substrate and evaporating a solvent in the droplet by feeding a gas to the droplet; and
a step of contacting the droplet with the detection reagent.

2. The method for detecting an analyte according to claim 1, wherein the detection reagent is immobilized on the substrate.

3. The method for detecting an analyte according to claim 1, wherein the solvent in the droplet is evaporated by heating the droplet.

4. The method for detecting an analyte according to claim 1, wherein the concentration of the solvent in the gas is decreased.

5. The method for detecting an analyte according to claim 1, wherein the detection reagent is a biomolecule.

6. The method for detecting an analyte according to claim 1, wherein the biomolecule includes at least one of an amino acid, a peptide, a protein and a nucleic acid.

7. A biochip for detecting an analyte in a sample liquid, comprising:
a substrate with an immobilized detection reagent which reacts specifically with the analyte contained in the sample liquid to give structural information on the analyte;
a space formed on the substrate, for contacting the detection reagent with the droplet of the sample liquid;
an inflow channel connecting to an end of the space, for feeding a gas to the droplet; and
an outflow channel connecting to the opposite side of the space, for venting the gas from the space,
wherein a hydrophobic region is formed on the substrate in the space.

8. The biochip according to claim 7, wherein a hydrophilic region is formed inside the hydrophobic region.

9. The biochip according to claim 7, wherein a hollow is formed in the space to accommodate the sample liquid.

10. The biochip according to claim 7, wherein the inflow channel and the outflow channel are microchannels with an equivalent diameter of 1 mm or less.

11. The biochip according to claim 7, wherein an apparatus for heating the droplet in the space is provided.

12. The biochip according to claim 7, wherein an apparatus for adjusting the concentration of a solvent in the gas is provided.

13. The biochip according to claim 7, wherein the detection reagent is a biomolecule.

14. The biochip according to claim 7, wherein the biomolecule includes at least one of an amino acid, a peptide, a protein and a nucleic acid.
